(19) United States
(12) Patent Application Publication
(10) Pub. No.: US 2005/0084011 A1
(43) Pub. Date: Apr. 21, 2005

(54) Apparatus for and method of detecting and compensating luminance change of each partition in moving picture

(75) Inventors: Byung-cheol Song, Suwon-si (KR); Kang-suk Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/864,875

(22) Filed: Jun. 10, 2004

(30) Foreign Application Priority Data
Jun. 10, 2003 (KR) 03-37132

(51) Int. Cl. H04N 7/12

(52) U.S. Cl. 375/240.12; 375/240.2; 375/240.24

(57) ABSTRACT

Disclosed are an apparatus and method for encoding a moving picture. A method of detecting and compensating a luminance change of each partition of a moving picture includes: calculating a luminance change value between a predetermined object partition and a predetermined reference partition corresponding to the predetermined object partition from pixel values of blocks in the predetermined object partition and pixel values of blocks in the predetermined reference partition; and compensating a luminance value of the predetermined reference partition using the calculated luminance change value, wherein the predetermined object partition is one of a plurality of object partitions included in an object picture, and the predetermined reference partition is one of a plurality of reference partitions included in a reference picture. Accordingly, encoding and decoding of a moving picture is performed efficiently even when a brightness change exists only in part of a picture frame or part of a VOP.

### CROSS-REFERENCE TO RELATED APPLICATIONS

This application claims the priority of Korean Patent Application No. 2003-37132, filed on Jun. 10, 2003, in the Korean Intellectual Property Office, the disclosure of which is incorporated herein in its entirety by reference.

### BACKGROUND OF THE INVENTION

1. Field of the Invention

The present invention relates to an apparatus and method for coding a moving picture, and also, to an apparatus and method for decoding a moving picture.

2. Description of the Related Art

Motion estimation/compensation is widely used as a coding technology for transmitting moving picture data effectively. In this technology, a picture to be coded (hereinafter “object picture”) is not transmitted as is, but position differences between partitions of the object picture and corresponding partitions of an already coded picture (hereinafter “reference picture”) are detected and transmitted by estimating the motion of the object picture using the reference picture. Therefore, even though small amounts of data are transmitted, there is achieved almost the same effect as transmitting the object picture as is.

It is assumed that motion detection is achieved under the same light condition. That is, with respect to the object picture and the reference picture, a motion is detected by assuming that the same objects have the same luminance values. The luminance values of the objects are very different when brightness changes in time, such as when a flicker or strobe phenomenon occurs, or when a fade-in or fade-out phenomenon occurs during controlling the diaphragm of a camera lens.

To improve a coding efficiency when the same luminance change occurs all over the picture, a prior art detects, codes, and transmits the luminance change in the picture.

FIG. 1 is a block diagram of a conventional apparatus for coding a moving picture.

With reference to FIG. 1, a conventional apparatus for coding a moving picture includes an input terminal 1, frame memories 2 and 3, a motion estimation unit 4, a luminance change detection unit 5, a frequency calculator 6, a luminance change compensation unit 7, an output terminal 8, a frame memory 9, a motion estimation and compensation unit 10, a subtracter 11, a discrete cosine transformer 12, a quantizer 13, an output terminal 14, an inverse quantizer 15, an inverse discrete cosine transformer 16, an adder 17 and an output terminal 18. The apparatus for coding a moving picture is disclosed in Japanese Patent Publication No. Heisei 10-136385.

Frame memories 2 and 3 temporarily store an object picture input via the input terminal 1. The object picture is used as a reference picture in a coding procedure of a next object picture. The motion estimation unit 4 calculates a motion estimation value of an object picture on the basis of a reference picture stored in the frame memory 3. A luminance change detection unit 5 calculates a parameter defining a gain change (hereinafter “gain change parameter”) and a parameter defining a contrast change (hereinafter “contrast change parameter”) from pixel values of blocks of the object picture and pixel values of blocks of the reference picture in a position moved as much as a motion estimation value calculated in the motion estimation unit 4.

In the past, the gain change parameter was used as a parameter defining a global luminance change amount. However, the conventional apparatus uses the gain change parameter and the contrast change parameter to define the global luminance change amount. That is, when the gain change parameter is G and the contrast change parameter is C, a luminance change is compensated by modifying a luminance value X of a pixel as shown in Equation 1.
X′=C·X+G [Equation 1]

A luminance change amount ΔX is as follows.
ΔX=X′−X=(C−1)·X+G [Equation 2]

Since the luminance change amount ΔX depends on the luminance value X of each pixel in a picture, coding efficiency is improved when the same luminance change is generated on the entire picture.

A frequency calculator 6 calculates a frequency of a gain change parameter and a contrast change parameter calculated in the luminance change detection unit 5 of each block in the object picture, and determines a gain change parameter and a contrast change parameter having the highest frequency from among the calculated frequencies as a global gain change parameter and contrast change parameter of the object picture. The global gain change parameter and contrast change parameter calculated in the frequency calculator 6 is output to outside via an output terminal 8. The luminance change compensation unit 7 compensates a luminance value of a reference picture stored in the frame memory 9 by using the global gain change parameter and contrast change parameter calculated in the frequency calculator 6.

The motion estimation and compensation unit 10 calculates a motion estimation value of the object picture and a motion compensation value of the reference picture on the basis of a reference picture having a luminance value compensated in the luminance change compensation unit 7. The motion compensation value calculated in the motion estimation and compensation unit 10 is output to outside via the output terminal 18. The subtracter 11 calculates a data difference value between the object picture and the reference picture by subtracting a motion compensation value calculated in the motion estimation and compensation unit 10 and a position moved as much as a motion estimation value calculated in the motion estimation and compensation unit 10 from data of the object picture. The discrete cosine transformer 12 performs a discrete cosine transform (DCT) on the data difference value calculated in the subtracter 11. The quantizer 13 quantizes a DCT value calculated in the discrete cosine transformer 12. The quantization value calculated in the quantizer 13 is output to outside via the output terminal 14. The inverse quantizing unit 15 inverse-quantizes the quantization value calculated in the quantizer 13. The inverse discrete cosine transformer 16 performs an inverse discrete cosine transform (IDCT) on the inverse-quantization value calculated in the inverse quantizing unit 15. The adder 17 generates an object picture by adding a motion compensation value calculated in the motion estimation and compensation unit 10 and a position moved as much as a motion estimation value calculated in the motion estimation and compensation unit 10 to the IDCT value calculated in the inverse discrete cosine transformer 16. The generated object picture is temporarily stored in the frame memory 9. The generated object picture is used as a reference picture in a coding procedure of a next object picture.

According to the conventional technology described above, since the luminance value is compensated by using Equation 2, coding efficiency is improved when the same luminance change is generated for an entire picture frame or an entire video object plane. However, when a luminance change is generated for only a part of a picture frame or a part of the video object plane, the decoding efficiency decreases.

FIG. 2 is a block diagram of a conventional apparatus for decoding a moving picture. With reference to FIG. 2, the conventional apparatus for decoding a moving picture includes input terminals 21, 22, and 23, an inverse quantizing unit 24, an inverse discrete cosine transformer 25, an adder 26, an output terminal 27, a frame memory 28, a luminance change compensation unit 29, and a motion compensation unit 30. The conventional apparatus for decoding a moving picture is disclosed in Japanese Patent Publication No. Heisei 10-136385.

The inverse quantizing unit 24 inverse-quantizes a quantization value input via the input terminal 21. The inverse discrete cosine transformer 25 performs an IDCT on the inverse-quantization value calculated in the inverse quantizing unit 24. The luminance change compensation unit 29 compensates a luminance value of a reference picture by using a luminance change value input via the input terminal 23. The motion compensation unit 30 extracts a motion compensation value of a reference partition of the reference picture having a compensated luminance value input via the input terminal 22. The adder 26 generates an object picture by adding the extracted motion compensation value to the IDCT value calculated in the inverse discrete cosine transformer 25.

The conventional apparatus for decoding a moving picture corresponds to the conventional apparatus for coding a moving picture shown in FIG. 1, and since a luminance value is also compensated by using Equation 2, coding efficiency is improved when the same luminance change is generated for an entire picture frame or an entire video object plane. However, when the luminance change is generated for only a part of a picture frame or a part of the video object plane, the decoding efficiency decreases.

### SUMMARY OF THE INVENTION

The present invention provides an apparatus for and method of coding a moving picture with high efficiency, and an apparatus for and method of decoding a moving picture with high efficiency, when a brightness change occurs in a portion of the moving picture.

According to another aspect of the present invention, there is provided a method of detecting and compensating a luminance change of each partition of a moving picture, the method comprising: calculating a luminance change value between a predetermined object partition and a predetermined reference partition corresponding to the predetermined object partition from pixel values of blocks in the predetermined object partition and pixel values of blocks in the predetermined reference partition; and compensating a luminance value of the predetermined reference partition using the calculated luminance change value, wherein the predetermined object partition is one of a plurality of object partitions included in an object picture, and the predetermined reference partition is one of a plurality of reference partitions included in a reference picture.

According to another aspect of the present invention, there is provided a method of compensating a luminance change of each partition of a moving picture, the method comprising: compensating a luminance value of a predetermined reference partition of a reference picture using a luminance change value between a predetermined object partition among a plurality of object partitions included in an object picture and the predetermined reference partition corresponding to the predetermined object partition among a plurality of reference partitions included in the reference picture; and extracting a part in a position moved as much as a motion estimation value between the reference picture and the object picture from the reference picture including a reference partition having the compensated luminance value.

According to another aspect of the present invention, there is provided an apparatus for compensating a luminance change of each partition of a moving picture, the apparatus comprising: a unit for compensating a luminance change of each partition, which compensates a luminance value of a predetermined reference partition of a reference picture using a luminance change value between a predetermined object partition among a plurality of object partitions included in an object picture and the predetermined reference partition corresponding to the predetermined object partition among a plurality of reference partitions included in the reference picture; and a motion compensation unit, which extracts a part in a position moved as much as a motion estimation value between the reference picture and the object picture from the reference picture including a reference partition having the compensated luminance value.

According to another aspect of the present invention, there is provided a method of decoding a moving picture, the method comprising: compensating a luminance value of a predetermined reference partition among a plurality of reference partitions included in a reference picture; and decoding an object picture on the basis of the reference picture having the compensated luminance value.

According to another aspect of the present invention, there is provided a computer readable medium having recorded thereon a computer readable program for executing a method of compensating a luminance change of each partition of a moving picture.

According to another aspect of the present invention, there is provided a computer readable medium having recorded thereon a computer readable program for executing a method of decoding a moving picture.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional apparatus for coding a moving picture;

FIG. 2 is a block diagram of a conventional apparatus for decoding a moving picture;

FIG. 3 shows an exemplary embodiment of a reference picture and an object picture of a moving picture, according to the present invention;

FIG. 4 is a block diagram of an apparatus for detecting and compensating a luminance change of each partition of a moving picture and an apparatus for coding a moving picture, according to an exemplary embodiment of the present invention;

FIG. 5 is a detailed block diagram of a unit for detecting a brightness change of partitions shown in FIG. 4;

FIG. 6 is a detailed block diagram of a unit for detecting a luminance change of partitions shown in FIG. 4;

FIG. 7 is a block diagram of an apparatus for compensating a luminance change of each partition of a moving picture and an apparatus for decoding a moving picture, according to an exemplary embodiment of the present invention;

FIG. 8A is a flowchart of a method of detecting and compensating a luminance change of each partition of a moving picture, according to an exemplary embodiment of the present invention;

FIG. 8B is a detailed flowchart of the step 84 shown in FIG. 8A;

FIG. 8C is a detailed flowchart of the step 85 shown in FIG. 8A;

FIG. 9 is a flowchart of a method of coding a moving picture, according to an exemplary embodiment of the present invention;

FIG. 10 is a flowchart of a method of compensating a luminance change of each partition of a moving picture, according to an exemplary embodiment of the present invention; and

FIG. 11 is a flowchart of a method of decoding a moving picture, according to an exemplary embodiment of the present invention.

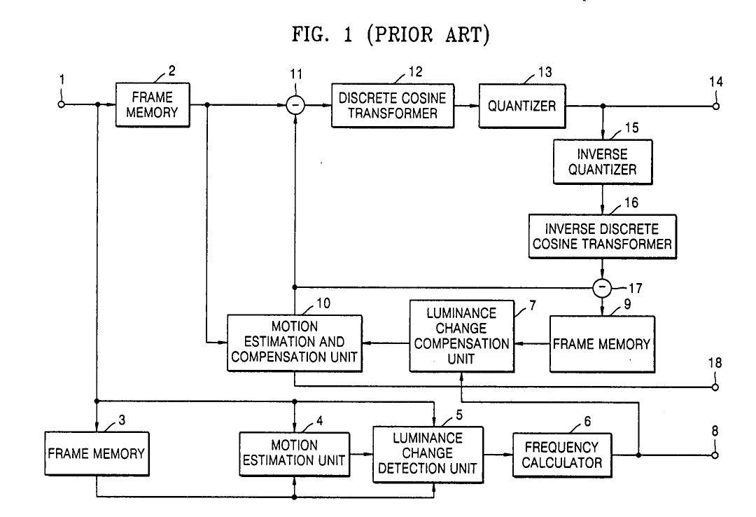

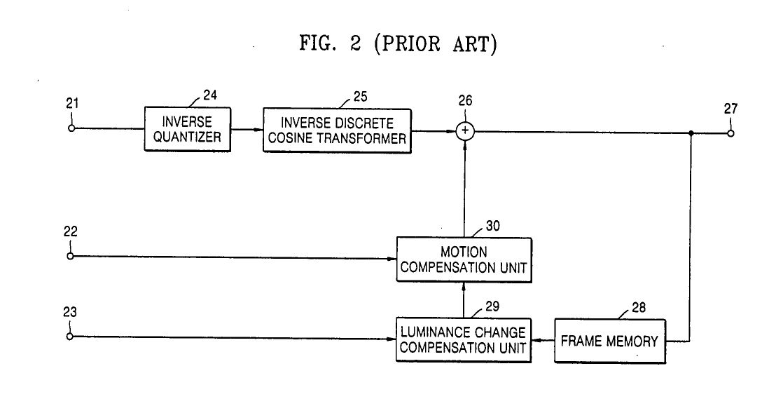

### DETAILED DESCRIPTION OF THE INVENTION

The present invention will now be described more fully with reference to the accompanying drawings, in which embodiments of the invention are shown.

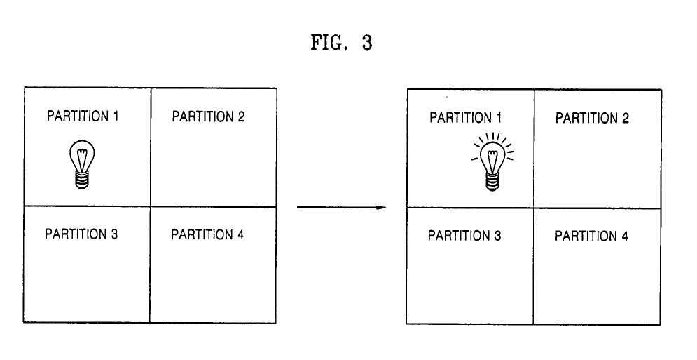

FIG. 3 shows an exemplary embodiment of a reference picture and an object picture of a moving picture, according to the present invention.

With reference to FIG. 3, a picture on the left is the reference picture, which is an already coded picture, and a picture on the right is the object picture, which is a picture to be coded. In the case of the reference picture, a lamp is turned off while in the case of the object picture, the lamp is slightly moved to the right and turned on. Since the conventional technology relates to the case where an entire picture has the same brightness, it cannot work effectively in the case where a part of a picture is getting brighter as shown in a FIG. 3. In this case, it is necessary to divide the picture into an appropriate number of partitions, detect a luminance change of each partition, and finally compensate a luminance value of a reference picture according to the detected luminance change. For example, the picture is divided into 4 partitions, and only a partition on the left upper corner will be detected having a luminance change. The picture may be divided into any number of equal or unequal partitions, the minimum size of a partition being equal to the size of a macroblock unit. In a procedure of coding and decoding a moving picture, since the macroblock is the operation unit of a DCT for quantization and variable length coding, a picture may not be divided into partitions smaller than the macroblock.

The picture is called a picture frame or a video object plane of the moving picture experts group (MPEG) 4 standard, hereinafter.

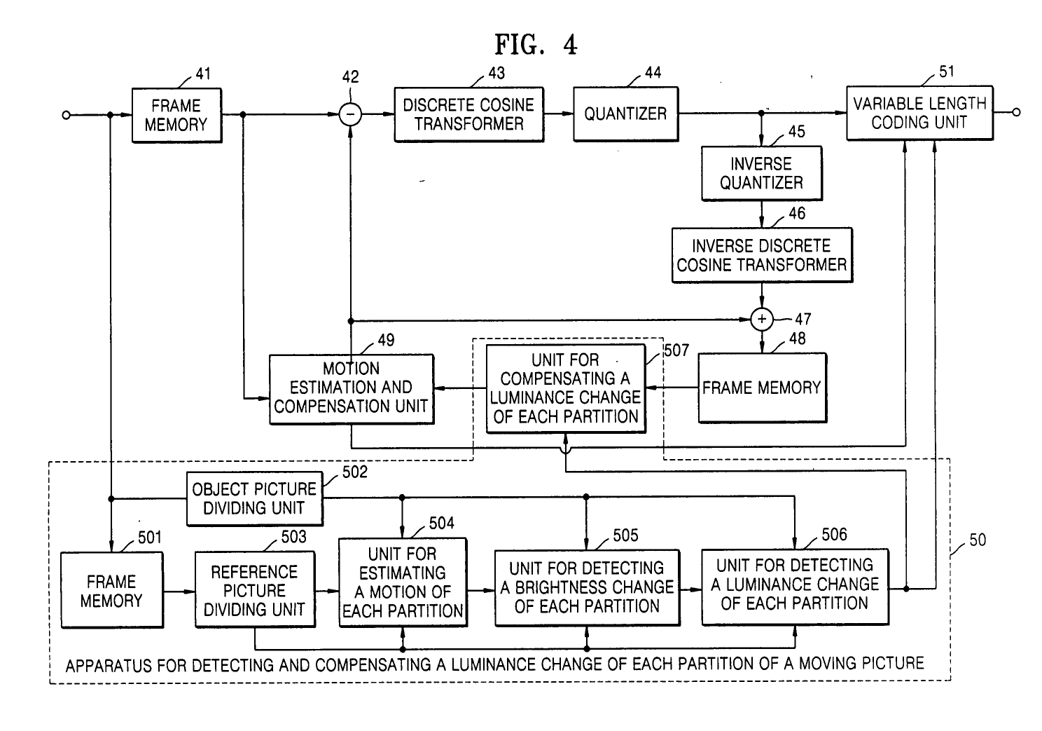

FIG. 4 is a block diagram of an apparatus for detecting and compensating a luminance change of each partition of a moving picture and an apparatus for coding a moving picture, according to an exemplary embodiment of the present invention. With reference to FIG. 4, the apparatus 50 for detecting and compensating a luminance change of each partition of a moving picture includes a frame memory 501, an object picture dividing unit 502, a reference picture dividing unit 503, a unit for estimating a motion of each partition 504, a unit for detecting a brightness change of each partition 505, a unit for detecting a luminance change of each partition 506, and a unit for compensating a luminance change of each partition 507.

The object picture dividing unit 502 divides an object picture input via an input terminal into N object partitions. The number of partitions must be adequately selected by considering a resolution of the object picture and an operation efficiency. That is, since the higher a resolution of a picture, the more accurate a luminance change and compensation, the more the number of partitions, and the better a quality of a picture. However, if the number of partitions is too large, the computational amount is very large and the speed of coding and decoding a moving picture is very slow.

The reference picture dividing unit 503 divides a reference picture stored in the frame memory 501 into N reference partitions. Generally, the reference picture may be a picture just prior to the object picture.

The unit for estimating a motion of each partition 504 calculates a motion estimation value of an object partition obtained in the object picture dividing unit 502 on the basis of a reference partition obtained in the reference picture dividing unit 503. For example, a motion of the object partition may be estimated on the basis of the reference partition by applying a block matching technique to every block of 8 x 8 pixels. In general, the estimated motion is expressed with a motion vector. When a resolution of a picture is low, that is, when it is not necessary to perform a luminance change and compensation precisely, the unit for estimating a motion of each partition 504 may be unnecessary, which could reduce sharply the computational amount. However, in the case of a moving picture, there is in general a motion between partitions corresponding to each other, and in order to compensate a luminance change more precisely, it must be checked whether there is the luminance change between partitions exactly corresponding to each other.

The unit for detecting a brightness change of each partition 505 determines whether there is a brightness change in an object partition on the basis of an absolute difference between the brightness of an object partition and the brightness of a reference partition in a position moved as much as the motion estimation value calculated in the unit for estimating a motion of each partition 504. In the case where there is a motion between objects corresponding to each other as shown in FIG. 3, when an object on the reference picture is moved as much as the direction and magnitude of the motion vector calculated in the unit for estimating a motion of each partition 504, it is exactly matched to the object on the object picture. Therefore, the unit for detecting a brightness change of each partition 505 may determine exactly whether there is a brightness change in an object partition by comparing a brightness of an object partition and a brightness of the moved reference partition. The unit for detecting a brightness change of each partition 505 may be unnecessary when it is not necessary to detect a brightness change of each partition due to a low resolution of a picture. When the unit for detecting a brightness change of each partition 505 is excluded, like in the case of the unit for estimating a motion of each partition 504, the computational amount is reduced sharply. In general, it is not only more efficient but also it requires less computational amount to detect a brightness change of each partition and perform a luminance change detection and compensation of only the partition in which a brightness change is detected.

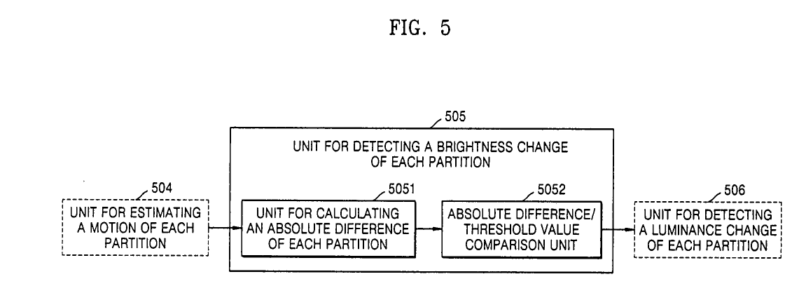

FIG. 5 is a detailed block diagram of a unit for detecting a brightness change of partition 505 shown in FIG. 4.

With reference to FIG. 5, a unit for detecting a brightness change of each partition 505 includes a unit for calculating an absolute difference of each partition 5051 and an absolute difference/threshold value comparison unit 5052.

The unit for calculating an absolute difference of each partition 5051 calculates an absolute difference between a brightness of an object partition and a brightness of a reference partition in a position moved as much as a motion estimation value calculated in the unit for estimating a motion of each partition 504, that is, a brightness of a reference partition corresponding to the object partition. For example, when a brightness of an object partition is 1 lux and a brightness of a reference partition corresponding to the object partition is 10 lux, an absolute difference of the brightness is 9 lux.

The absolute difference/threshold value comparison unit 5052 compares an absolute difference calculated in the unit for calculating an absolute difference of each partition 5051 with a threshold value, determines that there is a brightness change in the object partition if the absolute difference is larger than the threshold value, and determines that there is no brightness change in the object partition if the absolute difference is not larger than the threshold value. For example, if the threshold value is 5 lux, since the absolute difference of the prior example is 9 lux, the absolute difference is larger than the threshold value, and therefore, it is determined that there is a brightness change in the applicable object partition. If the threshold value is 10 lux, since the absolute difference of the prior example is 9 lux, the absolute difference is not larger than the threshold value, and therefore, it is determined that there is no brightness change in the applicable object partition. The threshold value is set by a user in consideration of a brightness of an entire moving picture.

The unit for detecting a luminance change of each partition 506 calculates a luminance change value between an object partition and a reference partition from pixel values of blocks in the object partition and pixel values of blocks in the reference partition corresponding to the object partition. When the unit for estimating a motion of each partition 504 is included in the apparatus of FIG. 4, the unit for detecting a luminance change of each partition 506 calculates a luminance change value between the object partition and the reference partition from pixel values of blocks in the object partition and pixel values of blocks in the reference partition in a position moved as much as a motion estimation value calculated in the unit for estimating a motion of each partition 504. When both the unit for estimating a motion of each partition 504 and the unit for detecting a brightness change of each partition 505 are included in the apparatus of FIG. 4, the unit for detecting a luminance change of each partition 506 calculates a luminance change value between the object partition and the reference partition from pixel values of blocks in the object partition, in which a brightness change is detected in the unit for detecting a brightness change of each partition 505, and pixel values of blocks in the reference partition in a position moved as much as the motion estimation value calculated in the unit for estimating a motion of each partition 504.

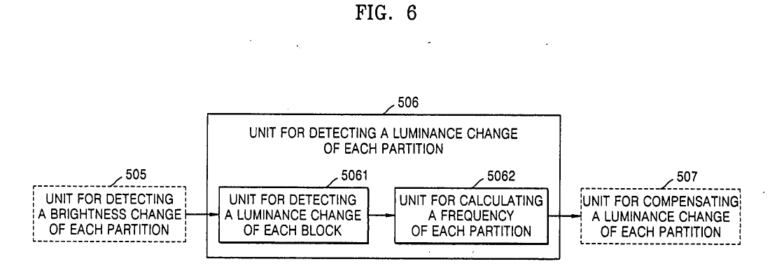

FIG. 6 is a detailed block diagram of a unit for detecting a luminance change of each partition 506 shown in FIG. 4.

With reference to FIG. 6, the unit for detecting a luminance change of each partition 506 includes a unit for detecting a luminance change of each block 5061 and a unit for calculating a frequency of each partition 5062.

The unit for detecting a luminance change of each block 5061 calculates a gain change parameter and a contrast change parameter from pixel values of blocks in the object partition, in the case where a brightness change was detected in the absolute difference/threshold value comparison unit 5052, and pixel values of blocks in a reference partition in a position moved as much as a motion estimation value calculated in the unit for estimating a motion of each partition 504. The gain change parameter G and the contrast change parameter C may be calculated using Equation 3.
[Equation 3]

$$J = {\sum }_{y = 1}^{y} {\sum }_{x = 1}^{x} {[ O ( x , y ) - \{ C ( i ) \cdot R ( x , y ) + G ( i ) \} ]}^{2} \qquad [ Equation 3 ]$$

where G(i) and C(i) are parameters of an i^{th} block, and O(x, y) is pixel values of a block in the object partition, and R(x, y) is pixel values of a block in the reference partition. Parameters G and C are calculated for the case where a difference between pixel values of a block in the object partition and pixel values of a block in the reference partition is minimum. That is, the parameters G and C are time parameters obtained by performing a spatial differentiation with respect to O(x, y) and R(x, y) when J is equal to 0.

The unit for calculating a frequency of each partition 5062 calculates a frequency of a gain change parameter and a contrast change parameter calculated in the unit for detecting a luminance change of each block 5061 of respective blocks in an object partition, in the case where there is a brightness change, and determines a gain change parameter and a contrast change parameter having the highest frequency from among the calculated frequencies as a global gain change parameter and a global contrast change parameter of the object partition. For example, in the case of an object partition of 8×8 blocks and if a brightness change was detected, the gain change parameters and contrast change parameters of the 16 blocks are determined from Equation 3. At this time, the most frequent gain change parameter and contrast change parameter are set as the global gain change parameter and the global contrast change parameter of the object partition.

The unit for compensating a luminance change of each partition 507 compensates a luminance value of a reference partition by using the luminance change value calculated in the unit for detecting a luminance change of each partition 506, that is, the global gain change parameter and global contrast change parameter set in the unit for calculating a frequency of each partition 5062. That is, the unit for compensating a luminance change of each partition 507 compensates a luminance change by modifying a luminance value X of each pixel in a reference partition by using Equation 2.

With reference to FIG. 4, an apparatus for coding a moving picture includes a frame memory 41, a subtracter 42, a discrete cosine transformer 43, a quantizer 44, an inverse quantizer 45, an inverse discrete cosine transformer 46, an adder 47, a frame memory 48, a motion estimation and compensation unit 49, an apparatus for detecting and compensating a luminance change of each partition of a moving picture 50, and a variable length coder 51.

If a picture is input to the apparatus for coding a moving picture, the input picture is temporarily stored in the frame memory 41, and is simultaneously input to the apparatus 50 for detecting and compensating a luminance change of each partition of a moving picture. The picture stored in the frame memory 41 is an object picture to be coded, and is temporarily stored to be compared to a reference picture stored in the frame memory 48, that is, a reference picture which is already coded.

The apparatus 50 for detecting and compensating a luminance change of each partition of a moving picture divides an object picture into N partitions, divides a reference picture into N partitions, calculates a luminance change value between the object partition and the reference partition from pixel values of blocks in the object partition and pixel values of blocks in the reference partition corresponding to the object partition, and finally compensates a luminance value of the reference partition by using the calculated luminance change value. When the apparatus 50 for detecting and compensating a luminance change of each partition of a moving picture has a motion estimation function, the apparatus 50 also calculates a motion estimation value of an object partition divided on the basis of a divided reference partition, and a luminance change value between an object partition and a reference partition from pixel values of blocks in the object partition and pixel values of blocks in the reference partition in a position moved as much as the calculated motion estimation value. When the apparatus 50 has a motion estimation function and a brightness change detection function, the apparatus 50 determines whether there is a brightness change in an object partition on the basis of an absolute difference between the brightness of the object partition and the brightness of the reference partition in a position moved as much as the calculated motion estimation value, and also calculates a luminance change value between the object partition and the reference partition from pixel values of blocks in the object partition, in a case where it is determined that there is a brightness change, and pixel values of blocks in a reference partition in a position moved as much as the calculated motion estimation value.

The motion estimation and compensation unit 49 calculates a motion estimation value and a motion compensation value of an object picture on the basis of a reference picture including a reference partition having a luminance value compensated in the apparatus 50. As such, in a case where there is a brightness change, the object partition has the same luminance as the reference partition corresponding to the object partition. Therefore, since a luminance change occurs on a part of the reference picture corresponding to the object picture having the same luminance change only on the same part thereof, a motion estimation value and a motion compensation value of an object picture on the basis of a reference picture is exactly calculated. At this time, the motion estimation value is generally a motion vector, and the motion compensation value is the same part of the reference picture as the part of the object picture indicated by the motion vector. That is, the motion compensation value does not mean a newly added picture but an existing picture in a position determined when the object picture is compared to the reference picture. Of course, the position may be fixed as in the case of a background picture. By not directly transmitting parts corresponding to a motion compensation value but transmitting just moving information such as a motion estimation value to an apparatus for decoding a moving picture, a decoding procedure is performed by applying the moving information to data of an already decoded picture in the apparatus for decoding a moving picture.

The subtracter 42 calculates a data difference value between the object picture and the reference picture by subtracting the motion compensation value calculated in the motion estimation and compensation unit 49 and a position moved as much as a motion estimation value calculated in the motion estimation and compensation unit 49 from data of the object picture. As described above, since the motion compensation value is common data between the object picture and the reference picture, the data difference value between the object picture and the reference picture is calculated by subtracting the motion compensation value from data of the object picture.

The discrete cosine transformer 43 performs a DCT on the data difference value calculated in the subtracter 42. If the method of estimating and compensating a motion is a time correlation compressing method, the discrete cosine transformer 43 performs a space correlation compressing method. If a DCT is performed for a block unit for 8×8 pixels, irregular pixel values of a picture are concentrated toward low frequency terms.

The quantizer 44 quantizes the DCT value calculated in the discrete cosine transformer 43. The quantizer 44 eliminates high frequency terms by dividing all terms of DCT blocks of 8×8 pixels by a quantization step Q. The information compression may be performed without information loss through the above operation.

The inverse quantizer 45 inverse-quantizes the quantization value calculated in the quantizer 44. That is, the inverse quantizer 45 multiplies the quantization step Q to all terms of blocks of 8×8 pixels divided by the quantization step Q in the quantizer 44.

The inverse discrete cosine transformer 46 performs an IDCT on the inverse-quantization value calculated in the inverse quantizer 45. That is, the inverse discrete cosine transformer 46 performs an IDCT for every inverse-quantization block of 8×8 pixels.

The adder 47 generates the object picture by adding the motion compensation value calculated in the motion estimation and compensation unit 49 and a position moved as much as a motion estimation value calculated in the motion estimation and compensation unit 49 to the IDCT value calculated in the inverse discrete cosine transformer 46. The IDCT value calculated in the inverse discrete cosine transformer 46 is almost same as a value input to the discrete cosine transformer 43. That is, the IDCT value calculated in the inverse discrete cosine transformer 46 is the data difference value between the object picture and the reference picture. The object picture is generated by adding the data difference value between the object picture and the reference picture to a position moved as much as the motion estimation value and the motion compensation value, that is, common data between the object picture and the reference picture. The generated object picture is temporarily stored in the frame memory 48, and is used as a reference picture of a next object picture.

The variable length coder 51 generates an output stream by performing a variable length coding (VLC) on the quantization value calculated in the quantizer 44, the motion compensation value calculated in the motion estimation and compensation unit 49, and the luminance change value calculated in the apparatus 50. The VLC is a compressing method which shortens the length of a total code stream by assigning a short length code to a value having high generation capability of the quantization value, a motion compensation value, and a luminance change value, and by assigning a long length code to a value having low generation capability of the quantization value, the motion compensation value, and the luminance change value. The compressed code stream is then transmitted to an apparatus for decoding a moving picture via variable communication tools.

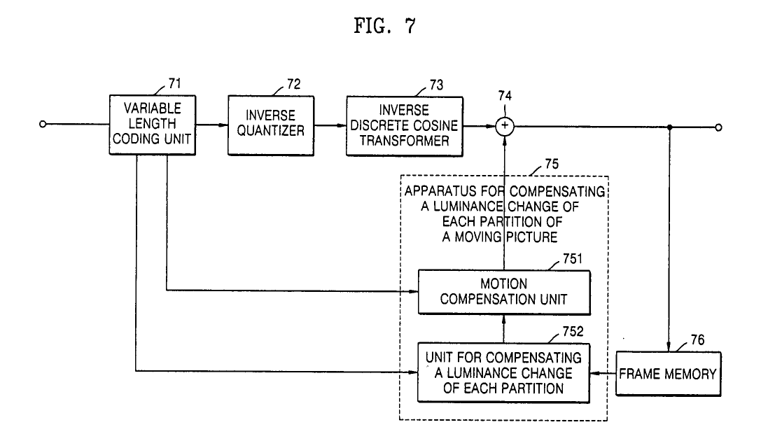

FIG. 7 is a block diagram of an apparatus for compensating a luminance change of each partition of a moving picture and an apparatus for decoding a moving picture, according to an exemplary embodiment of the present invention.

With reference to FIG. 7, the apparatus 75 for compensating a luminance change of each partition of a moving picture includes a motion compensation unit 751 and a unit for compensating a luminance change of each partition 752.

The unit for compensating a luminance change of each partition 752 compensates a luminance value of a reference partition by using a luminance change value between an object partition in an object picture and a reference partition corresponding to the object partition in a reference picture. If a luminance change is detected after a brightness change is detected in an apparatus for coding a moving picture, the motion compensation unit 751 compensates a luminance value of the reference partition by using a luminance change value between the reference partition and the object partition, if there is a brightness change in the object picture. The luminance change value is a global gain change parameter and global contrast change parameter of the object partition. That is, the luminance value of the reference partition is compensated using Equation 2. If the luminance value of the reference partition is compensated, the reference partition having the compensated luminance value has the same brightness as the object partition and exact motion compensation is possible.

The motion compensation unit 751 extracts a part in a position moved as much as a motion estimation value between the reference picture and the object picture from the reference picture including the reference partition having the luminance value compensated in the unit for compensating a luminance change of each partition 752. The extracted part has the same meaning as defined by a motion compensation value in a procedure of decoding a moving picture. Also, the extracted part does not mean a newly added part but an existing part in a position determined when the object picture is compared to the reference picture. Of course, the position may be fixed as in the case of a background picture. The common part between the reference picture and the object picture is not received from the apparatus for decoding a moving picture but used to select an already decoded picture, that is, a reference picture. At this time, information received from the apparatus for decoding a moving picture is the motion information of the common part, that is, the motion estimation value.

With reference to FIG. 7, the apparatus for decoding a moving picture includes a variable length decoder 71, an inverse quantizing unit 72, an inverse discrete cosine transformer 73, an adder 74, an apparatus 75 for compensating a luminance change of each partition of a moving picture, and a frame memory 76.

The variable length decoder 71 performs a variable length decoding (VLD) on an input stream. When the input stream passes through the variable length decoder 71, a quantization value, a motion compensation value, and a luminance change value are output.

The inverse quantizing unit 72 inverse-quantizes a quantization value included in the VLD value calculated in the variable length decoder 71. When the quantization value output from the variable length decoder 71 passes through the inverse quantizing unit 72, a DCT value is output.

The inverse discrete cosine transformer 73 performs an IDCT on the inverse quantization value calculated in the inverse quantizing unit 72. When the DCT value output from the inverse quantizing unit 72 passes through the inverse discrete cosine transformer 73, a data difference value between a reference picture, which is an original data, and an object picture is output.

The apparatus 75 for compensating a luminance change of each partition of a moving picture compensates a luminance value of a reference partition corresponding to an object partition in an object picture by using the luminance change value included in the VLD value calculated in the variable length decoder 71, and also extracts a motion compensation value, that is, a part in a position moved as much as the motion estimation value included in a VLD value calculated in the variable length decoder 71 from a reference picture including the reference partition having a compensated luminance value. When a luminance change is detected after a brightness change is detected in the apparatus for coding a moving picture, the apparatus 75 for compensating a luminance change of each partition of a moving picture compensates a luminance value of the reference partition by using a luminance change value between the object partition, in a case where there is a brightness change in the object picture, and the reference partition. The luminance change value is a global gain change parameter and a global contrast change parameter of the object partition.

The adder 74 generates an object picture by adding the part extracted in the apparatus 75, that is, a motion compensation value to an IDCT value calculated in the inverse discrete cosine transformer 73, that is, a data difference value between the reference picture and the object picture.

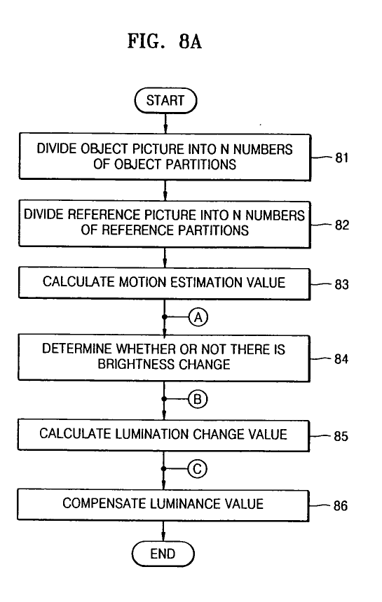

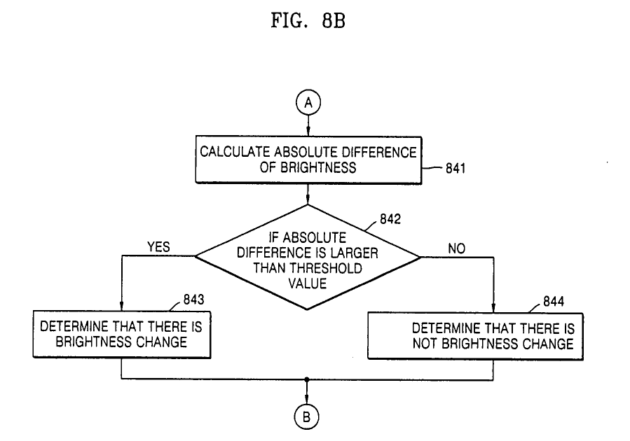

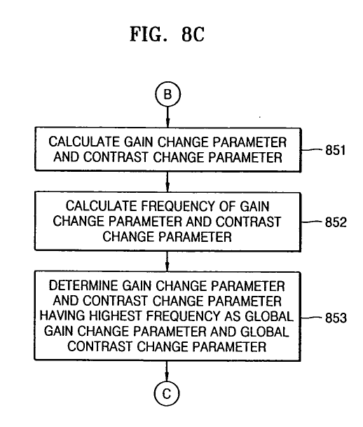

FIG. 8A is a flowchart of a method of detecting and compensating a luminance change of each partition of a moving picture, according to an exemplary embodiment of the present invention.

With reference to FIG. 8A, the method of detecting and compensating a luminance change of each partition of a moving picture includes the following steps.

An object picture is divided into N object partitions in step 81. Subsequently, a reference picture is divided into N reference partitions in step 82. Then, a motion estimation value of an object partition is calculated in step 83 on the basis of a corresponding reference partition. Next, it is determined whether there is a brightness change in the object partition on the basis of an absolute difference between a brightness of the object partition and a brightness of the reference partition in a position moved as much as the calculated motion estimation value in step 84.

FIG. 8B is a detailed flowchart of the step 84 shown in FIG. 8A.

With reference to FIG. 8B, the step 84 shown in FIG. 8A includes the following sub-steps.

The absolute difference between the brightness of the object partition and the brightness of the reference partition in a position moved as much as the calculated motion estimation value is calculated in step 841. After this, the calculated absolute difference is compared to a threshold value in step 842, and then, it is determined in step 843 that there is a brightness change in the object partition if the absolute difference is larger than the threshold value. If not, it is determined in step 844 that there is no brightness change in the object partition.

With reference to FIG. 8A again, a luminance change value between the object partition and the reference partition is calculated in step 85 from pixel values of blocks in the object partition having a brightness change and pixel values of blocks in the reference partition in a position moved as much as the calculated motion estimation value.

FIG. 8C is a detailed flowchart of the step 85 shown in FIG. 8A.

With reference to FIG. 8C, the step 85 shown in FIG. 8A includes the following sub-steps.

A gain change parameter and a contrast change parameter are calculated in step 851 from pixel values of blocks in the object partition having a brightness change and pixel values of blocks in the reference partition in a position moved as much as the calculated motion estimation value. Then, a frequency of the calculated gain change parameter and contrast change parameter is calculated in step 852 for each block in the object partition having a brightness change, and then, a gain change parameter and a contrast change parameter having the highest frequency from among the calculated frequencies are set in step 853 as a global gain change parameter and a global contrast change parameter of the object partition having a brightness change.

Subsequently, a luminance value of the reference partition is compensated in step 86 by using the calculated luminance change value, that is, by using the determined global gain change parameter and global contrast change parameter.

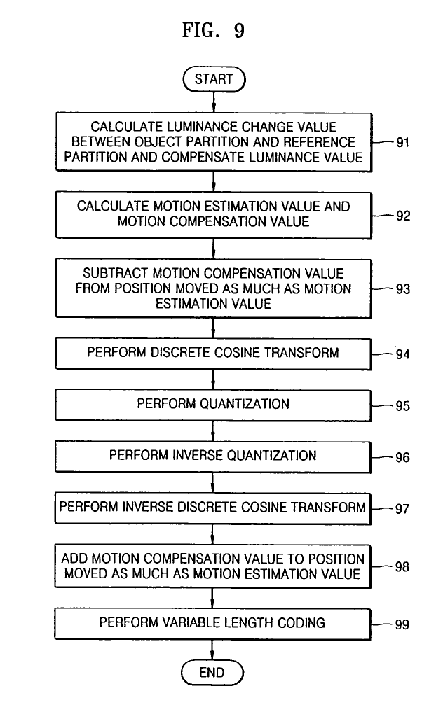

FIG. 9 is a flowchart of a method of coding a moving picture, according to an exemplary embodiment of the present invention.

With reference to FIG. 9, the method of coding a moving picture includes the following steps.

An object picture is divided into N object partitions, and next, a reference picture is divided into N reference partitions. Then, a luminance change value between an object partition and a corresponding reference partition is calculated from pixel values of blocks in the object partition and pixel values of blocks in the corresponding reference partition. Finally, a luminance value of the reference partition is compensated in step 91 using the calculated luminance change value. If a motion estimation step is added, a motion estimation value of the object partition based on the reference partition is calculated, and also a luminance change value between the object partition and the reference partition is calculated from pixel values of blocks in the object partition and pixel values of blocks in the reference partition in a position moved as much as the calculated motion estimation value. If the motion estimation step and a brightness change detection step are added, it is determined whether or not there is a brightness change in the object partition on the basis of the absolute difference between the brightness of the object partition and the brightness of the reference partition in a position moved as much as the calculated motion estimation value, and also a luminance change value between the object partition and the reference partition is calculated from,pixel values of blocks in the object partition having a brightness change and pixel values of blocks in the reference partition in a position moved as much as the calculated motion estimation value.

Thereafter, a motion estimation value and a motion compensation value between the reference picture and the object picture are calculated in step 92 on the basis of the reference picture including the reference partition having the compensated luminance value. Then, a data difference value between the object picture and the reference picture is calculated in step 93 by subtracting a calculated motion estimation value and motion compensation value and a position moved as much as a calculated motion estimation value from data of the object picture. Next, a DCT on the calculated data difference value is performed in step 94, the DCT value is quantized in step 95, and the quantization value is inverse-quantized in step 96. Subsequently, an IDCT on the inverse-quantization value is performed in step 97. Then, a new object picture is generated in step 98 by adding the calculated motion compensation value and a position moved as much as the calculated motion estimation value to the IDCT value. Finally, an output stream is generated in step 99 by performing a VLC on the quantization value, the calculated motion compensation value, and the calculated luminance change value.

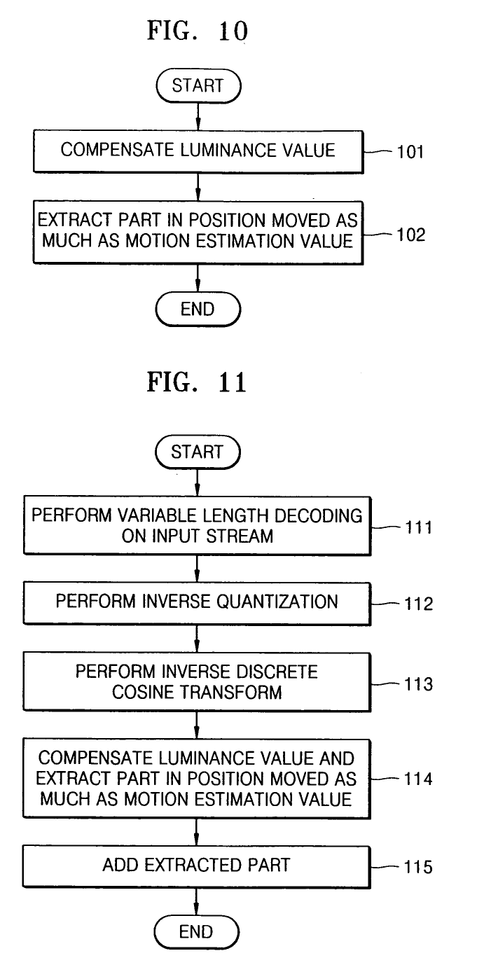

FIG. 10 is a flowchart of a method of compensating a luminance change of each partition of a moving picture, according to an exemplary embodiment of the present invention.

With reference to FIG. 10, the method of compensating a luminance change of each partition of a moving picture includes the following steps.

A luminance value of a reference partition is compensated in step 101 by using a luminance change value between an object partition in an object picture and the reference partition in a reference picture corresponding to the object partition. If a luminance change is detected after a brightness change is detected in the step of coding a moving picture, the luminance value of the reference partition is compensated by using the luminance change value between the object partition having a brightness change in an object picture and the reference partition. The luminance change value is a global gain change parameter and a global contrast change parameter of the object partition. Thereafter, a part in a position moved as much as a motion estimation value between the reference picture and the object picture is extracted in step 102 from the reference picture including the reference partition having the compensated luminance value.

FIG. 11 is a flowchart of a method of decoding a moving picture, according to an exemplary embodiment of the present invention.

With reference to FIG. 11, the method of decoding a moving picture includes the following steps.

A variable length decoding (VLD) on an input stream is performed in step 111. Subsequently, a quantization value included in the VLD value is inverse-quantized in step 112. Next, an IDCT on the inverse quantization value is performed in step 113. Then, a luminance value of a reference partition corresponding to an object partition in an object picture is compensated by using a luminance change value included in the VLD value, and also a part in a position moved as much as a motion estimation value included in the VLD value is extracted from a reference picture including the reference partition having a compensated luminance value in step 114. If a luminance change is detected after a brightness change is detected in step of coding the moving picture, a luminance value of the reference partition is compensated by using a luminance change value between the object partition having a brightness change in an object picture and the reference partition. The luminance change value is a global gain change parameter and a global contrast change parameter of the object partition.

The present invention may be embodied in a general-purpose computer by running a program from a computer readable medium, including but not limited to storage media such as magnetic storage media (ROMs, RAMs, floppy disks, magnetic tapes, etc.), optically readable media (CD-ROMs, DVDs, etc.), and carrier waves (transmission over the Internet).

According to the present invention, encoding and decoding of a moving picture is performed efficiently not only when a brightness change exists in an entire picture frame or an entire VOP, but also when a brightness change exists only in a part of a picture frame or a part of a VOP. Also, according to the present invention, since only a luminance value of the detected part is compensated by detecting a part of the picture frame or a part of the VOP where a brightness change exists, the efficiency of encoding and decoding a moving picture increases significantly.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of detecting and compensating a luminance change of each partition of a moving picture, the method comprising:
(a) calculating a luminance change value between a predetermined object partition and a predetermined reference partition corresponding to the predetermined object partition from pixel values of blocks in the predetermined object partition and pixel values of blocks in the predetermined reference partition; and
(b) compensating a luminance value of the predetermined reference partition using the calculated luminance change value,
wherein the predetermined object partition is one of a plurality of object partitions included in an object picture, and the predetermined reference partition is one of a plurality of reference partitions included in a reference picture.

2. The method of claim 1, wherein step (a) comprises:
calculating the luminance change value from pixel values of blocks in the predetermined object partition and pixel values of blocks in the predetermined reference partition in a position corresponding to a predetermined motion estimation value.

3. The method of claim 1, further comprising:
(c) determining whether or not there is a brightness change in the predetermined object partition on the basis of an absolute difference between the brightness of the predetermined object partition and the brightness of the predetermined reference partition, and
step (a) comprises:
calculating the luminance change value from pixel values of blocks in the predetermined object partition, in which it is determined that there is the brightness change, and pixel values of blocks in the predetermined reference partition.

4. The method of claim 3, wherein step (c) comprises:
(c1) calculating an absolute difference between a brightness of the predetermined object partition and a brightness of the predetermined reference partition; and
(c2) comparing the calculated absolute difference and a threshold value and determining that there is a brightness change in the case of the predetermined object partition where the absolute difference is larger than the threshold value.

5. The method of claim 1, wherein step (a) comprises:
(a1) calculating a gain change parameter and a contrast change parameter from pixel values of blocks in the predetermined object partition having a brightness change and pixel values of blocks in the predetermined reference partition; and
(a2) calculating frequencies of the calculated gain change parameter and contrast change parameter and determining the gain change parameter and contrast change parameter having the highest frequency of the calculated frequencies as a global gain change parameter and global contrast change parameter of the predetermined object partition having the brightness change.

6. The method of claim 5, wherein step (b) comprises:
compensating a luminance value of the predetermined reference partition using the determined global gain change parameter and global contrast change parameter.

7. A method of compensating a luminance change of each partition of a moving picture, the method comprising:
(a) compensating a luminance value of a predetermined reference partition of a reference picture using a luminance change value between a predetermined object partition among a plurality of object partitions included in an object picture and the predetermined reference partition corresponding to the predetermined object partition among a plurality of reference partitions included in the reference picture; and
(b) extracting a part in a position corresponding to a motion estimation value between the reference picture and the object picture from the reference picture including a reference partition having the compensated luminance value.

8. The method of claim 7, wherein step (a) comprises:
compensating a luminance value of the predetermined reference partition using a luminance change value between the object predetermined partition having a brightness change in the object picture and the predetermined reference partition.

9. The method of claim 7, wherein the luminance change value is a global gain change parameter and a global contrast change parameter of the object partition.

10. An apparatus for compensating a luminance change of each partition of a moving picture, the apparatus comprising:
a unit for compensating the luminance change of each partition, which compensates a luminance value of a predetermined reference partition of a reference picture using a luminance change value between a predetermined object partition among a plurality of object partitions included in an object picture and the predetermined reference partition corresponding to the predetermined object partition among a plurality of reference partitions included in the reference picture; and
a motion compensation unit, which extracts a part in a position corresponding to a motion estimation value between the reference picture and the object picture from the reference picture including a reference partition having the compensated luminance value.

11. The apparatus of claim 10, wherein the unit for compensating the luminance change of each partition compensates a luminance value of the predetermined reference partition by using a luminance change value between the predetermined object partition having a brightness change in the object picture and the predetermined reference partition.

12. The apparatus of claim 10, wherein the luminance change value is a global gain change parameter and global contrast change parameter of the predetermined object partition.

13. A method of decoding a moving picture, the method comprising:
(a) compensating a luminance value of a predetermined reference partition among a plurality of reference partitions included in a reference picture; and
(b) decoding an object picture on the basis of the reference picture having the compensated luminance value.

14. The method of claim 13, wherein step (a) comprises:
compensating a luminance value of the predetermined reference partition using a luminance change value between a predetermined object partition having a brightness change among a plurality of object partitions included in the object picture and the predetermined reference partition corresponding to the predetermined object partition.

15. The method of claim 14, wherein the luminance change value is a global gain change parameter and global contrast change parameter of the object partition.

16. The method of claim 13, further comprising:
(c) performing variable length decoding on an input stream, and step (a) comprises:
compensating a luminance value of the predetermined reference partition using the luminance change value included in the variable length decoded value obtained in step (c).

17. The method of claim 13, wherein step (b) comprises:
(b1) extracting a part in a position corresponding to a motion estimation value between the reference picture and an object picture from the reference picture; and
(b2) generating the object picture by adding the part extracted in step (b1).

18. The method of claim 17, further comprising:
(d) inverse-quantizing a quantized value included in the variable length decoded value;
(e) performing an inverse discrete cosine transform on the inverse quantized value obtained in step (d), and
step (b) comprises:
adding the part extracted in step (b1) to the inverse discrete cosine transformed value obtained in step (e).

19. A computer readable medium having recorded thereon a computer readable program for executing a method of compensating a luminance change of each partition of a moving picture, the method comprising:
compensating a luminance value of a predetermined reference partition of a reference picture using a luminance change value between a predetermined object partition among a plurality of object partitions included in an object picture and the predetermined reference partition corresponding to the predetermined object partition among a plurality of reference partitions included in the reference picture; and
extracting a part in a position corresponding to a motion estimation value between the reference picture and the object picture from the reference picture including a reference partition having the compensated luminance value.

20. A computer readable medium having recorded thereon a computer readable program for executing a method of decoding a moving picture, the method comprising:
compensating a luminance value of a predetermined reference partition among a plurality of reference partitions included in a reference picture; and
decoding an object picture on the basis of the reference picture having the compensated luminance value.
